(19) United States
(12) Patent Application Publication
(10) Pub. No.: US 2017/0059922 A1
(43) Pub. Date: Mar. 2, 2017

(54) DISPLAY DEVICE

(71) Applicant: Shenzhen China Star Optoelectronics Technology Co., Ltd., Shenzhen, Guangdong (CN)

(72) Inventor: Yanxi YE, Shenzhen, Guangdong (CN)

(21) Appl. No.: 14/892,197

(22) PCT Filed: Aug. 27, 2015
(86) PCT No.: PCT/CN2015/088265

§ 371 Date: Nov. 19, 2015

(30) Foreign Application Priority Data
Aug. 25, 2015 (CN) 201510526057.X

(51) Int. Cl. G02F 1/1335; G02F 1/1339; G02F 1/1343; G02F 1/1368

(52) U.S. Cl. CPC G02F 1/133512; G02F 1/1368; G02F 1/133514; G02F 1/13394; G02F 1/134309; G02F 1/13439; G02F 1/1339; G02F 2201/121; G02F 2201/123; G02F 2203/05

(57) ABSTRACT

A display device is disclosed. The display device includes a first component assembling substrate, a second component assembling substrate, a light-blocking spacing member layer, a common electrode, a first electrode, a second electrode, and a pixel electrode. The light-blocking spacing member layer is disposed on a first surface of the first component assembling substrate. The first electrode is connected to the common electrode, and the second electrode is disposed at the peripheral region. A conductive member is connected to the first electrode and the second electrode. The present invention can allow the common electrode to receive signals provided by a second panel.

### BACKGROUND OF THE INVENTION

Field of the Invention

The present invention relates to a field of display technology, and more particularly to a display device.

Description of Prior Art

A conventional display device based on the BCS (Black Column Spacer) technique can reduce a process of BM (Black Matrix) in the manufacturing processes of the display device.

The aforementioned BCS technique uses a black material, which substitutes the conventional BM in a non-display region of the conventional display device based on the BCS technique to effect blocking light.

Common electrodes and pixel electrodes are respectively provided in a first panel and a second panel of the conventional display device based on the BCS technique. However, a portion of the common electrodes on the first panel in the non-display region of the conventional display device are covered with the black material. Namely, the black material separates the common electrodes from signal lines on the second panel. At this point, the common electrodes cannot receive signals provided by the second panel.

Therefore, it is necessary to propose a new technical solution to solve the technical problems above.

### SUMMARY OF THE INVENTION

The objective of the present invention is to provide a display device, which can allow a common electrode on a first panel to receive signals provided by a second panel under the premise of avoiding light leakage phenomenon shown in a non-display region of the display device.

To solve the foregoing problems, the present invention provides the following technical solutions.

According to one embodiment of the present invention, a display device divided into a display region and a peripheral region, which is disposed on at least one side of the display region, the display device comprises:

a first panel comprising:
a first component assembling substrate;
a light-blocking spacing member layer disposed on a first surface of the first component assembling substrate, wherein the first surface is a surface where the first component assembling substrate faces the liquid crystal layer, the light-blocking spacing member layer comprises a first member and a second member, and the first member is located at the peripheral region while the second member is located at the display region;
a common electrode disposed on the first surface; and
a first electrode located at the peripheral region and disposed on a surface where the first member faces the liquid crystal layer, and being connected to the common electrode;

a second panel comprising:
a second component assembling substrate;
a pixel electrode disposed on a second surface of the second component assembling substrate, wherein the second surface is a surface where the second component assembling substrate faces the liquid crystal layer, and the pixel electrode is located at the display region; and
a second electrode disposed on the second surface and located at the peripheral region;

the liquid crystal layer disposed between the first panel and the second panel; and

a conductive member disposed between the first panel and second panel, the conductive member being located at the peripheral region and connected to the first electrode and the second electrode;

wherein the first member is configured for blocking a light from the display region directed to the peripheral region;

wherein the second member is configured for blocking a light from a first pixel unit directed to a second pixel unit, the first pixel unit and the second pixel unit are both located at the display region;

wherein the second member is also used to support or auxiliarily supports the first panel and second panel, such that there is a gap between the first panel and the second panel.

In the above display device, when the second member is used to auxiliarily support the first panel and second panel, the second panel further comprises:

a third member disposed between two adjacent pixel electrodes and being in contact with the second member, the third member being used to, together with the second member, collaboratively support the first panel and the second panel to have the gap existing between the first panel and the second panel.

In the above display device, the third member is stacked by a first color blocking section and a second color blocking section; the first color blocking section is one of a red color blocking section, a green color blocking section, and a blue color blocking section while the second blocking section is another one of the red color blocking section, the green color blocking section, and the blue color blocking section.

In the above display device, wherein the common electrode covers sides of the second member and a surface where the second member faces the liquid crystal layer.

In the above display device, the common electrode is provided with a through-hole that penetrates through the common electrode and is located at the display region, and the second member runs through the through-hole from the first surface and protrudes from the common electrode.

In the above display device, the through-hole is formed by etching the common electrode covered on the surface where the second member faces the liquid crystal layer and the sides of the second member.

In the above display device, the through-hole is formed by performing a mask process on the common electrode disposed on the first surface; the mask process corresponds to a photomask including a first region and a second region; there is a first light transmittance at the first region, which corresponds to the common electrode; and there is a second light transmittance at the second region, which corresponds to the through-hole.

According to another one embodiment of the present invention, a display device divided into a display region and a peripheral region disposed on at least one side of the display region, the display device comprises:

a first panel comprising:
a first component assembling substrate;
a light-blocking spacing member layer disposed on a first surface of the first component assembling substrate, wherein the first surface is a surface where the first component assembling substrate faces the liquid crystal layer, the light-blocking spacing member layer comprises a first member and a second member, and the first member is located at the peripheral region while the second member is located at the display region;
a common electrode disposed on the first surface; and
a first electrode located at the peripheral region and disposed on a surface where the first member faces the liquid crystal layer, and being connected to the common electrode;

a second panel comprising:
a second component assembling substrate;
a pixel electrode disposed on a second surface of the second component assembling substrate, wherein the second surface is a surface where the second component assembling substrate faces the liquid crystal layer, and the pixel electrode is located at the display region; and
a second electrode disposed on the second surface and located at the peripheral region;

the liquid crystal layer disposed between the first panel and the second panel; and

a conductive member disposed between the first panel and second panel, the conductive member being located at the peripheral region and connected to the first electrode and the second electrode.

In the above display device, the first member is configured for blocking a light from the display region directed to the peripheral region.

In the above display device, the second member is configured for blocking the light from a first pixel unit directed to a second pixel unit, the first pixel unit and the second pixel unit are both located at the display region; the second member is also used to support or auxiliarily supports the first panel and second panel, such that there is a gap between the first panel and the second panel.

In the above display device, when the second member is used to auxiliarily support the first panel and second panel, the second panel further comprises: a third member disposed between two adjacent pixel electrodes and being in contact with the second member, the third member being used to, together with the second member, collaboratively support the first panel and the second panel to have the gap existing between the first panel and the second panel.

In the above display device, the third member is stacked by a first color blocking section and a second color blocking section; the first color blocking section is one of a red color blocking section, a green color blocking section, and a blue color blocking section while the second blocking section is another one of the red color blocking section, the green color blocking section, and the blue color blocking section.

In the above display device, when the second member is used to auxiliarily block the light from a first pixel unit directed to a second pixel unit, the third member stacked by a first color blocking section and a second color blocking section is used to, together with the second member, collaboratively block the light from a first pixel unit directed to a second pixel unit.

In the above display device, the common electrode covers sides of the second member and a surface where the second member faces the liquid crystal layer.

In the above display device, the common electrode is provided with a through-hole that penetrates through the common electrode and is located at the display region; and the second member runs through the through-hole from the first surface and protrudes from the common electrode.

In the above display device, the through-hole is formed by etching the common electrode covered on the surface where the second member faces the liquid crystal layer and the sides of the second member.

In the above display device, the through-hole is formed by performing a mask process on the common electrode disposed on the first surface.

In the above display device, the mask process corresponds to a photomask including a first region and a second region; there is a first light transmittance at the first region, which corresponds to the common electrode; and there is a second light transmittance at the second region, which corresponds to the through-hole.

In the above display device, the display device further comprises a sealing member disposed between the first panel and the second panel and located at the peripheral region; and the conductive member is fixed inside the sealing member.

In the above display device, the conductive member is a copper ball.

In contrast to the prior art, the present invention can allow the common electrode on the first panel to receive signals provided by the second panel under the premise of avoiding light leakage phenomenon shown in the non-display region of the display device.

To allow the foregoing summary of the present invention to be more clearly understood, preferred embodiments, which proceed with reference to the accompanying drawings, are described in detail as follows.

### BRIEF DESCRIPTION OF THE DRAWINGS

FIG. 1 is a schematic diagram of a display device in accordance with a preferred embodiment of the present invention.

FIG. 2 is a cross-sectional schematic diagram of A-A′ section of the display panel of FIG. 1.

FIG. 3 is a cross-sectional schematic diagram of B-B′ section of the display panel of FIG. 1 in accordance with a first preferred embodiment of the present invention.

FIG. 4 is a cross-sectional schematic diagram of B-B′ section of the display panel of FIG. 1 in accordance with a second preferred embodiment of the present invention.

FIG. 5 is a schematic diagram of a common electrode shown in FIG. 4.

### DETAILED DESCRIPTION OF THE INVENTION

The terms used in this specification, “one embodiment” or “an embodiment” means that the description in connection with the embodiment serves as an example, instance, or illustration of the disclosure. Furthermore, the articles “a” and “an” as used in this specification and the appended claims should generally be construed to mean “one or multiple”, unless specified or clear from context to be directed to be a singular form.

The display panel of the present invention may be a TFT-LCD (Thin Film Transistor Liquid Crystal Display).

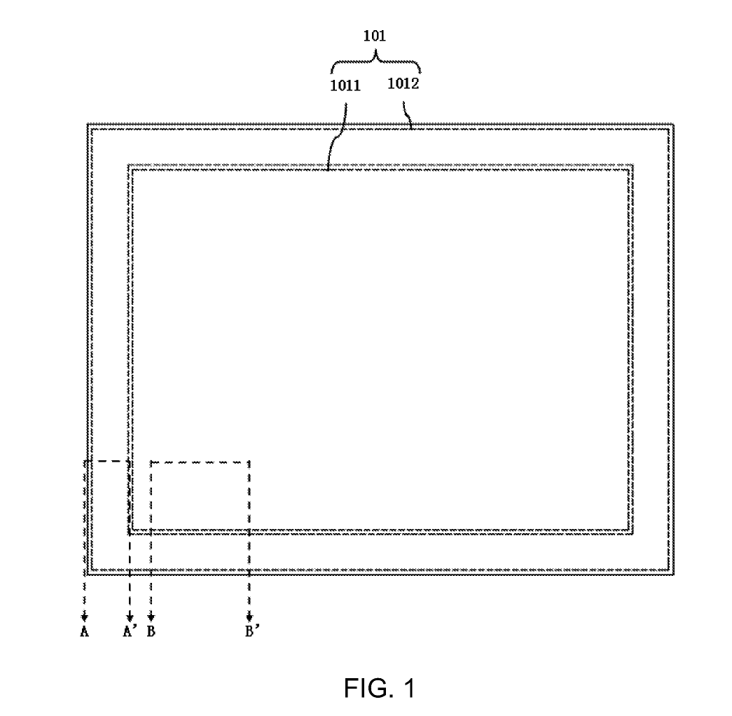

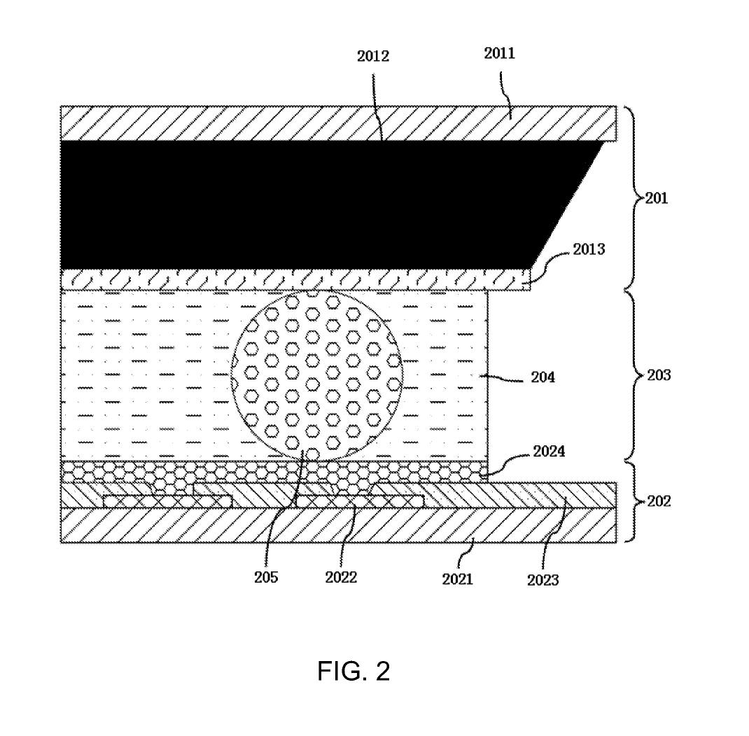

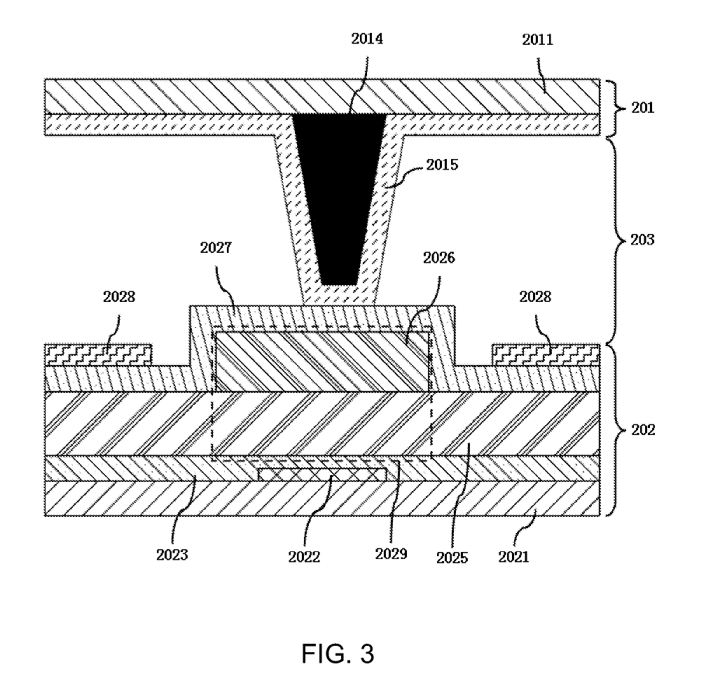

Referring to FIG. 1, FIG. 2 and FIG. 3, a schematic diagram of a display device in accordance with a preferred embodiment of the present invention is shown in FIG. 1. FIG. 2 is a cross-sectional schematic diagram of A-A′ section of the display panel of FIG. 1, and FIG. 3 is a cross-sectional schematic diagram of B-B′ section of the display panel of FIG. 1 in accordance with a first preferred embodiment of the present invention.

In this embodiment, the display device 101 is divided into a display region 1011 and a peripheral region 1012, and the peripheral region 1012 is disposed on at least one side of the display region 1011.

The display device 101 includes a first panel 201, a second panel 202, a liquid crystal layer, a sealing member 204, and a conductive member 205.

The liquid crystal layer is disposed between the first panel 201 and the second panel 202.

The sealing member 204 is disposed between the first panel 201 and the second panel 202, and the sealing member 204 is located at the peripheral region 1012.

The conductive member 205 is disposed between the first panel 201 and second panel 202, and the conductive member 205 is located at the peripheral region 1012. The conductive member 205 is connected to a first electrode 2013 and a second electrode 2024. The conductive member 205 is fixed inside the sealing member 204. The conductive member 205 may be, for example, a copper ball.

The first panel 201 includes a first component assembling substrate 2011, a light-blocking spacing member layer (2012-2014), a common electrode 2015, and the first electrode 2013. The light-blocking spacing member layer (2012-2014) is disposed on a first surface of the first component assembling substrate 2011, and the first surface is a surface where the first component assembling substrate 2011 faces the liquid crystal layer. The light-blocking spacing member layer (2012-2014) comprises a first member 2012 and a second member 2014, and the first member 2012 is located at the peripheral region 1012 while the second member 2014 is located at the display region 1011. The common electrode 2015 is disposed on the first surface. The first electrode 2013 is located at the peripheral region 1012, and the first electrode 2013 is disposed on a surface where the first member 2012 faces the liquid crystal layer and is connected to the common electrode 2015. The first electrode 2013 is configured for conducting electrical signals to the common electrode 2015.

The second panel 202 includes a second component assembling substrate, a pixel electrode 2028, and the second electrode 2024. The second component assembling substrate includes a substrate 2021, a signal line layer 2022, a first protective layer 2023, and a second protective layer 2027. The pixel electrode 2028 is disposed on a second surface of the second component assembling substrate, and the second surface is a surface where the second component assembling substrate 2012 faces the liquid crystal layer. The pixel electrode 2028 is located at the display region 1011. The second electrode 2024 is disposed on the second surface, and they are located at the peripheral region 1012.

In this embodiment, a color film (Color Filter) layer may be disposed in the first component assembling substrate 2011 of the first panel 201, alternatively, and it may be disposed in the second component assembling substrate of the second panel 202.

In this embodiment, the first member 2012 is configured for blocking the light from the display region 1011 directed to the peripheral region 1012.

In this embodiment, the second member 2014 is configured for blocking or auxiliarily blocking a light from a first pixel unit directed to a second pixel unit, in which the first pixel unit and the second pixel unit are both located at the display region 1011.

The second member 2014 is also used to support or auxiliarily supports the first panel 201 and second panel 202, such that there is a gap 203 between the first panel 201 and the second panel 202.

As for the case of the second member 2014 auxiliarily supporting the first panel 201 and second panel 202, the second panel 202 further includes a third member 2029. The third member 2029 is disposed between two adjacent pixel electrodes 2028, and the third member 2029 is in contact with the second member 2014. The third member 2029 is configured for auxiliarily supporting the first panel 201 and the second panel 202, namely, and the third member 2029 is used to, together with the second member 2014, collaboratively support the first panel 201 and the second panel 202 to have the gap 203 existing between the first panel 201 and the second panel 202.

As for the case of the second member 2014 blocking or auxiliarily blocking a light from a first pixel unit directed to a second pixel unit, the third member 2029 includes a first color blocking section 2025 and a second color blocking section 2026, that is the third member 2029 stacked by the first color blocking section 2025 and the second color blocking section 2026. The first color blocking section 2025 is one of a red color blocking section, a green color blocking section, and a blue color blocking section, and the second blocking section 2026 is another one of the red color blocking section, the green color blocking section, and the blue color blocking section. The third member 2029 stacked by the first color blocking section 2025 and the second color blocking section 2026 is used to, together with the second member, collaboratively block the light from the first pixel unit directed to the second pixel unit.

In this embodiment, the common electrode 2015 covers the sides of the second member 2014 and the surface where the second member 2014 faces the liquid crystal layer, as shown in FIG. 3.

With the above technical solution, the common electrode 2015 on the first panel 201 may receive signals provided by the second panel 202 through the first electrode 2013, the conductive member 205, and the second electrode 2024. That is, the preferred embodiment can allow the common electrode 2015 on the first panel 201 to receive the signals provided by the second panel 202 under the premise of avoiding light leakage phenomenon shown in the non-display region (the peripheral region 1012).

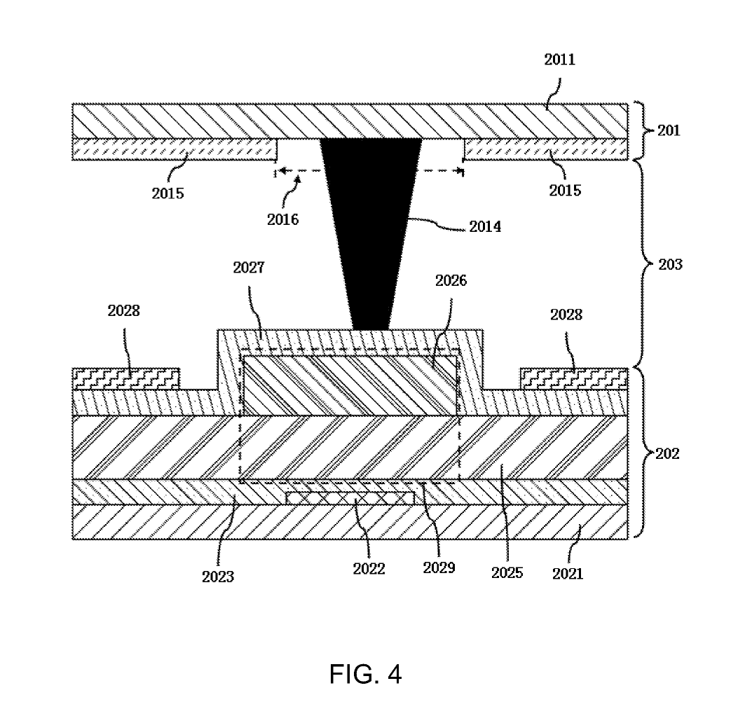

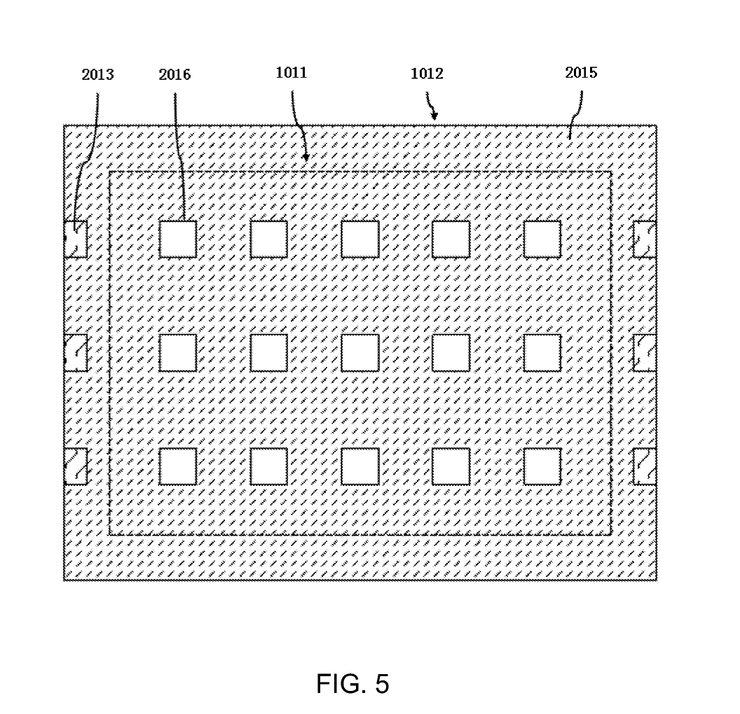

Referring to FIG. 4 and FIG. 5, a cross-sectional schematic diagram of B-B′ section of the display panel of FIG. 1 is shown in FIG. 4 according to a second preferred embodiment of the present invention. FIG. 5 is a schematic diagram of the common electrode shown in FIG. 4. The display device 101 in the second embodiment of the present invention is similar to the above-described first embodiment, the differences are as follows.

In the second embodiment, the common electrode 2015 is provided with a through-hole 2016, which penetrates through the common electrode 2015. The through-hole 2016 is located at the display region 1011.

The second member 2014 runs through the through-hole 2016 from the first surface, and the second member 2014 protrudes from the common electrode 2015.

The through-hole 2016 is formed by etching the common electrode 2015 covered on the surface where the second member 2014 faces the liquid crystal layer and the sides of the second member 2014.

Alternatively, the through-hole 2016 is formed by performing a mask process on the common electrode 2015 of the first surface. The mask process corresponds to a photomask including a first region and a second region. There is a first light transmittance at the first region, which corresponds to the common electrode 2015. There is a second light transmittance at the second region, which corresponds to the through-hole 2016.

With the above technical solutions, it can be avoided that there is an abnormal structure size appeared in the common electrode 2015 at the display region 1011, and it can be also avoided that the common electrode 2015 is fallen off from the first surface or other defects. Consequently, the common electrode 2015, covered on the surface where the second member 2014 faces the liquid crystal layer and the sides of the second member 2014, succeeds in eluding to form an electrical field which interferes the deflection of the liquid crystal molecules, and thus it can be avoided that Mura problem is appeared in the region corresponding to the second member 2014 in the display device 101.

Despite one or more preferred embodiments of the present invention having been illustrated and described, those having ordinary skills in the art may easily contemplate equivalent changes and modifications according to the disclosure and drawings of the present invention. All such modifications and variations are considered to be encompassed in the scope defined by the claims of the present invention. Particularly with regard to the various functions performed by the above-described components, the terms used to describe such components are intended to perform the specified function corresponding to the component, which may be performed by any other components (functionally equivalent unless otherwise indicated), even though other components are not the same in the structure as shown in the exemplary implementations of this specification. Furthermore, although a particular feature relating to a number of embodiments has been disclosed in this specification, this feature may be combined with one or more other features to have other embodiments which are desirable and advantageous to a given or particular application. Moreover, the terms “including”, “having”, “containing”, or variations thereof are used in the detailed description or the claims with a meaning similar to the term “comprising”.

In summary, while the present invention has been described with the aforementioned preferred embodiments, it is preferable that the descriptions relating to the above embodiments should be construed as exemplary rather than as limiting of the present invention. One of ordinary skill in the art can make a variety of modifications and variations without departing from the spirit and scope of the present invention as defined by the following claims.

1. A display device divided into a display region and a peripheral region disposed on at least one side of the display region, the display device comprising:
a first panel comprising:
a first component assembling substrate;
a light-blocking spacing member layer disposed on a first surface of the first component assembling substrate, the first surface being a surface where the first component assembling substrate faces a liquid crystal layer, the light-blocking spacing member layer comprising a first member and a second member, and the first member being located at the peripheral region while the second member being located at the display region;
a common electrode disposed on the first surface; and
a first electrode located at the peripheral region and disposed on a surface where the first member faces the liquid crystal layer, and being connected to the common electrode;
a second panel comprising:
a second component assembling substrate;
a pixel electrode disposed on a second surface of the second component assembling substrate, the second surface being a surface where the second component assembling substrate faces the liquid crystal layer, and the pixel electrode being located at the display region; and
a second electrode disposed on the second surface and located at the peripheral region;
the liquid crystal layer disposed between the first panel and the second panel; and
a conductive member disposed between the first panel and second panel, the conductive member being located at the peripheral region and connected to the first electrode and the second electrode;
wherein the first member is configured for blocking a light from the display region directed to the peripheral region;
wherein the second member is configured for blocking a light from a first pixel unit directed to a second pixel unit, the first pixel unit and the second pixel unit are both located at the display region;
wherein the second member is also used to support or auxiliarily supports the first panel and second panel, such that there is a gap between the first panel and the second panel.

2. The display device according to claim 1, wherein when the second member is used to auxiliarily support the first panel and second panel, the second panel further comprises:
a third member disposed between two adjacent pixel electrodes and being in contact with the second member, the third member being used to, together with the second member, collaboratively support the first panel and the second panel to have the gap existing between the first panel and the second panel.

3. The display device according to claim 21,
wherein the third member is stacked by a first color blocking section and a second color blocking section when the second member is used to auxiliarily blocking a light from a first pixel unit directed to a second pixel unit, in which the first color blocking section is one of a red color blocking section, a green color blocking section, and a blue color blocking section while the second blocking section is another one of the red color blocking section, the green color blocking section, and the blue color blocking section.

4. The display device according to claim 1, wherein the common electrode covers sides of the second member and a surface where the second member faces the liquid crystal layer.

5. The display device according to claim 1, wherein the common electrode is provided with a through-hole that penetrates through the common electrode and is located at the display region; and
the second member runs through the through-hole from the first surface and protrudes from the common electrode.

6. The display device according to claim 5, wherein the through-hole is formed by etching the common electrode covered on the surface where the second member faces the liquid crystal layer and the sides of the second member.

7. The display device according to claim 5, wherein the through-hole is formed by performing a mask process on the common electrode disposed on the first surface;
the mask process corresponds to a photomask including a first region and a second region;
there is a first light transmittance at the first region, which corresponds to the common electrode; and
there is a second light transmittance at the second region, which corresponds to the through-hole.

8. A display device divided into a display region and a peripheral region disposed on at least one side of the display region, the display device comprising:
a first panel comprising:
a first component assembling substrate;
a light-blocking spacing member layer disposed on a first surface of the first component assembling substrate, the first surface being a surface where the first component assembling substrate faces a liquid crystal layer, the light-blocking spacing member layer comprising a first member and a second member, and the first member being located at the peripheral region while the second member is located at the display region;
a common electrode disposed on the first surface; and
a first electrode located at the peripheral region and disposed on a surface where the first member faces the liquid crystal layer, and being connected to the common electrode;
a second panel comprising:
a second component assembling substrate;
a pixel electrode disposed on a second surface of the second component assembling substrate, the second surface being a surface where the second component assembling substrate faces the liquid crystal layer, and the pixel electrode being located at the display region; and
a second electrode disposed on the second surface and located at the peripheral region;
the liquid crystal layer disposed between the first panel and the second panel; and
a conductive member disposed between the first panel and second panel, the conductive member being located at the peripheral region and connected to the first electrode and the second electrode.

9. The display device according to claim 8, wherein the first member is configured for blocking a light from the display region directed to the peripheral region.

10. The display device according to claim 8, wherein the second member is configured for blocking the light from a first pixel unit directed to a second pixel unit, the first pixel unit and the second pixel unit are both located at the display region; and
the second member is also used to support or auxiliarily supports the first panel and second panel, such that there is a gap between the first panel and the second panel.

11. The display device according to claim 8, wherein when the second member is used to auxiliarily support the first panel and second panel, the second panel further comprises:
a third member disposed between two adjacent pixel electrodes and being in contact with the second member, the third member being used to, together with the second member, collaboratively support the first panel and the second panel to have the gap existing between the first panel and the second panel.

12. The display device according to claim 10, wherein the third member is stacked by a first color blocking section and a second color blocking section when the second member is used to auxiliary blocking a light from a first pixel unit directed to a second pixel unit; and the first color blocking section is one of a red color blocking section, a green color blocking section, and a blue color blocking section while the second blocking section is another one of the red color blocking section, the green color blocking section, and the blue color blocking section.

13. The display device according to claim 12, wherein when the second member is used to auxiliarily blocking the light from the first pixel unit directed to the second pixel unit, the third member stacked by a first color blocking section and a second color blocking section is used to, together with the second member, collaboratively block the light from a first pixel unit directed to a second pixel unit.

14. The display device according to claim 10, wherein the common electrode covers sides of the second member and a surface where the second member faces the liquid crystal layer.

15. The display device according to claim 10, wherein the common electrode is provided with a through-hole that penetrates through the common electrode and is located at the display region; and
the second member runs through the through-hole from the first surface and protrudes from the common electrode.

16. The display device according to claim 15, wherein the through-hole is formed by etching the common electrode covered on the surface where the second member faces the liquid crystal layer and the sides of the second member.

17. The display device according to claim 15, wherein the through-hole is formed by performing a mask process on the common electrode disposed on the first surface.

18. The display device according to claim 17, wherein the mask process corresponds to a photomask including a first region and a second region;
there is a first light transmittance at the first region, which corresponds to the common electrode; and
there is a second light transmittance at the second region, which corresponds to the through-hole.

19. The display device according to claim 8, wherein the display device further comprises:
a sealing member disposed between the first panel and the second panel and located at the peripheral region; and
the conductive member is fixed inside the sealing member.

20. The display device according to claim 19, wherein the conductive member is a copper ball.
